(19) United States
(12) Patent Application Publication
(10) Pub. No.: US 2021/0292985 A1
(43) Pub. Date: Sep. 23, 2021

(54) Physical catchment model for rainfall runoff experiment

(71) Applicant: REPUBLIC OF KOREA(MINISTRY OF THE INTERIOR AND SAFETY NATIONAL DISASTER MANAGEMENT RESEARCH INSTITUT, Ulsan (KR)

(72) Inventors: Hak Soo KIM, Busan (KR); Taek Jo KOH, Ulsan (KR); Sung Je YE, Ulsan (KR); Hyang Seo JEONG, Ulsan (KR); HYUN SUK SHIN, Busan (KR); Sang Min HA, Yangsan-si (KR)

(21) Appl. No.: 17/051,831

(22) PCT Filed: Apr. 19, 2019
(86) PCT No.: PCT/KR2019/004748

§ 371 Date: Oct. 30, 2020

(30) Foreign Application Priority Data
Dec. 7, 2018 (KR) 10-2018-0156999

(51) Int. Cl. E02B 1/02; G01M 10/00

(52) U.S. Cl. CPC E02B 1/02; G01M 10/00

(57) ABSTRACT

The present invention relates to a physical catchment model for a rainfall runoff experiment, characterized by being a physical catchment construction model having a structure in which a real terrain miniature is disposed at one side thereof and a developed terrain miniature is disposed at the adjacent other side thereof. According to the present invention, the rainfall runoff experiment is performed by collecting rainwater flowing out downwardly from the terrain miniatures through the application of artificial rainfall to the physical catchment model for the rainfall runoff experiment so as to easily compare and measure a change in the amount of rainwater flowing out for a predetermined time during rainfall in an undeveloped real terrain and a developed terrain, thereby enabling easy establishment of a national land use and development plan in the development planning stage for utilization of national land so that natural disasters caused by the rainfall runoff of land planned to be developed can be prevented in advance.

### TECHNICAL FIELD

The present invention relates to a physical catchment model for a rainfall runoff experiment, which has a structure in which a real terrain miniature is disposed at one side thereof and a developed terrain miniature is disposed at the adjacent other side thereof, wherein the rainfall runoff experiment is performed by collecting rainwater flowing out downwardly from the terrain miniatures through the application of artificial rainfall to the physical catchment model so as to easily compare and measure a change in the amount of rainwater flowing out for a predetermined time during rainfall in an undeveloped real terrain and a developed terrain, thereby enabling easy establishment of a national land use and development plan in the development planning stage for utilization of national land so that natural disasters caused by the rainfall runoff of land planned to be developed can be prevented in advance.

### BACKGROUND ART

In general, the national territory is developed for use as commercial, residential, or industrial areas designated by ‘the National Land Planning and Utilization Act (NPUA)’. The commercial area is organically arranged in the central area in conjunction with living convenience facilities, center business facilities, and the like in terms of the community plan. In addition, the commercial area is designated to be divided into a central commercial area, a general commercial area, a neighboring commercial area, and the like in order to ensure convenience of use and efficiency of business execution. The residential area is constructed such that a detached house, a middle-rise house, a high-rise house, and the like can be distributed properly to create a variety of landscapes. Further, the residential area is designated to be divided into a first class exclusive residential area, a second class exclusive residential area, a general residential area, and a semi-residential area.

In the South Korea's territory, approximately 70% of the country topography includes mountainous areas, and thus the mountainous areas are mainly cut and developed in order to efficiently utilize the national territory, and an environmental impact assessment is performed in advance for the developed areas. However, a system for predicting damage caused by rainfall runoff is not constructed sufficiently, which may cause a loss of many lives and property damage in a developed area after the development of the national territory.

In the meantime, as one example of prior art patent documents describing various technologies relating to a method of predicting damage caused by rainfall runoff, Korean Patent No. 10-1672810 (issued on Nov. 4, 2016) discloses a method of combining radar-based short-term precipitation forecasting with numerical weather prediction-based rainfall forecasts considering the orographic effect. As shown in FIG. 1, the above-mentioned Korean patent is directed to a technology for increasing accuracy and reliability of short-term precipitation data predicted based on reflectivity data observed by a weather radar for a real terrain. As another example, Korean Patent No. 10-1670903 (issued on Oct. 31, 2016) discloses a method of interpreting ground surface runoff using radar rainfall data. As shown in FIG. 2, the above-mentioned Korean patent is directed to a technology for enabling ground surface runoff interpretation conforming to a real environment by, in real-time, using mobile plane radar rainfall data upon the interpretation of ground surface runoff for a real terrain. However, the method of combining radar-based short-term precipitation forecasting with numerical weather prediction-based rainfall forecasts considering the orographic effect disclosed in the above Korean Patent No. 10-1672810 and the method of interpreting ground surface runoff using radar rainfall data disclosed in the above Korean Patent No. 10-1670903 are directed to technologies relating to a method of predicting future rainfall runoff damage to a local terrain. However, these technologies merely predict rainfall runoff damage to the local terrain, and no technology relating to a method of verifying the prediction of rainfall runoff damage to a developed terrain after the development of the local terrain has been developed yet.

### DISCLOSURE OF INVENTION

### Technical Problem

Accordingly, the present invention has been made in order to solve the above-described problems occurring in the prior art, and it is an object of the present invention is to provide a physical catchment model for a rainfall runoff experiment, which has a structure in which a real terrain miniature is disposed at one side thereof and a developed terrain miniature is disposed at the adjacent other side thereof, wherein the rainfall runoff experiment is performed by collecting rainwater flowing out downwardly from the terrain miniatures through the application of artificial rainfall to the physical catchment model so as to easily compare and measure a change in the amount of rainwater flowing out for a predetermined time during rainfall in an undeveloped real terrain and a developed terrain, thereby enabling easy establishment of a national land use and development plan in the development planning stage for utilization of national land so that natural disasters caused by the rainfall runoff of land planned to be developed can be prevented in advance.

Another object of the present invention is to provide a physical catchment model for a rainfall runoff experiment, which has a structure in which a plurality of real terrain subminiatures, each of which is formed with the same terrain as a real terrain, are assembled at one side thereof and a plurality of developed terrain subminiatures for a developed terrain are assembled at the adjacent other side thereof so as to easily measure a change in the amount of rainwater flowing out for a predetermined time during rainfall in an undeveloped real terrain and a developed terrain, thereby enabling easy establishment of a national land use and development plan in the development planning stage for utilization of national land so that natural disasters caused by the rainfall runoff can be prevented in advance.

### Technical Solution

To achieve the above objects, in on aspect, the present invention provides a physical catchment model for a rainfall runoff experiment, including: a real terrain miniature 100 formed by reducing a real terrain; a developed terrain miniature 200 formed by reducing the real terrain to a terrain which it is desired to develop according to a development plan; and a miniature-holding frame 300 disposed on the undersides of the real terrain miniature 100 and the developed terrain miniature 200 and configured to support the miniatures, wherein the physical catchment model has a structure in which the developed terrain miniature 200 is assembled to be disposed adjacent to the real terrain miniature 100, and further includes a rainwater tank 400 disposed below the miniature-holding frame 300.

In another aspect, the present invention provides a physical catchment model for a rainfall runoff experiment, including: a real terrain miniature 100 formed by assembling a plurality of real terrain subminiatures 100a formed by dividing and reducing a real terrain; a developed terrain miniature 200 formed by assembling a plurality of developed terrain subminiatures 200a formed by reducing the real terrain to a terrain which it is desired to develop according to a development plan; and a plurality of subminiature-holding frames 300a disposed on the undersides of the real terrain miniature 100 and the developed terrain miniature 200 and configured to support the miniatures, wherein the physical catchment model has a structure in which the developed terrain miniature 200 is assembled to be disposed adjacent to the real terrain miniature 100, and further includes a rainwater tank 400 disposed below the miniature-holding frame 300.

In the meantime, the real terrain miniature 100 and the developed terrain miniature 200 may be structured such that geotextile fabric layers 120 and 220 and soil layers 130 and 230 are respectively sequentially stacked on lower frames 110 and 210 each having a square flat plate shape.

In addition, the developed terrain miniature 200 may include a road 250 having a drainage channel 240 formed on one side or both sides thereof, and rainwater introduced into the drainage channel 240 may be collected in the rainwater tank 400 through a drain pipe. Each of the lower frames 110 and 210 may include a permeable surface structure or an impermeable surface structure, and the permeable surface structure may have a plurality of outlet holes 500 formed therein in such a manner as to be spaced apart from one another at predetermined intervals.

Further, the rainwater tank 400 may be implemented as a hexahedral structure with an open top surface to correspond to the shape of the entire undersides of the real terrain miniature 100 and the developed terrain miniature 200.

### Advantageous Effects

The physical catchment model for a rainfall runoff experiment according to the present invention has effects in that it has a structure in which a real terrain miniature is disposed at one side thereof and a developed terrain miniature is disposed at the adjacent other side thereof, so that it is possible to easily compare and measure a change in the amount of rainwater flowing out for a predetermined time during rainfall in an undeveloped real terrain and a developed terrain through the application of artificial rainfall to the physical catchment model, thereby enabling easy establishment of a national land use and development plan in the development planning stage for utilization of national land so that natural disasters caused by the rainfall runoff of land planned to be developed can be prevented in advance.

### BRIEF DESCRIPTION OF THE DRAWINGS

The above and other objects, features and advantages of the present invention will be more apparent from the following detailed description of the preferred embodiments of the invention in conjunction with the accompanying drawings, in which:

FIG. 1 is a view showing a domain of a numerical weather prediction model depending on combination of radar-based short-term precipitation forecast data with numerical weather prediction-based rainfall forecast data considering the orographic effect according to the prior art;

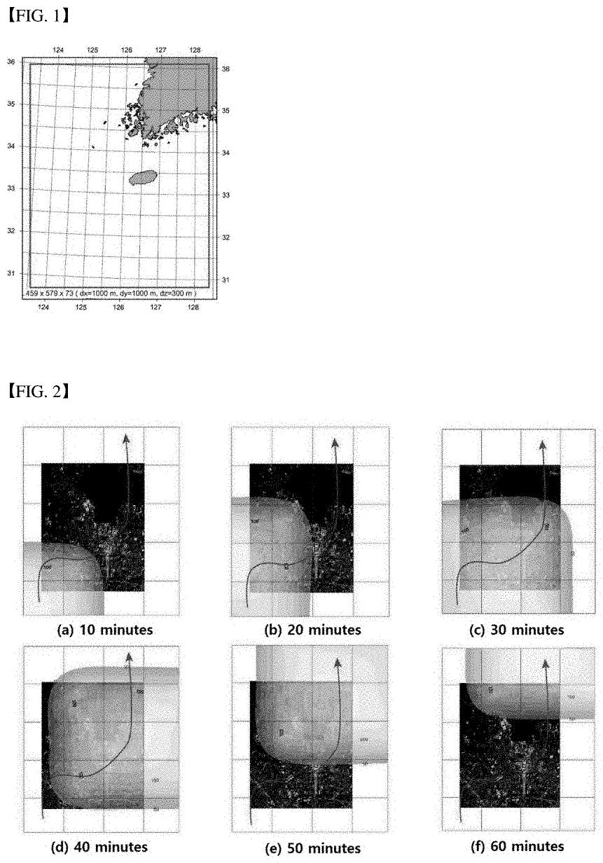

FIG. 2 is a view showing a method of moving virtual mobile rainfall for a real terrain according to the prior art;

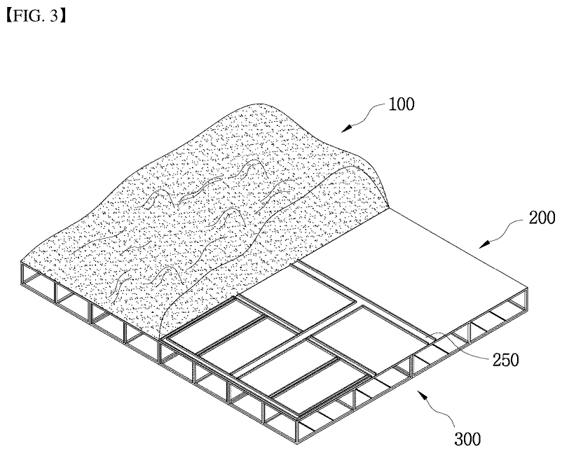

FIG. 3 is a top perspective view showing the entire structure of a physical catchment model for a rainfall runoff experiment according to the present invention;

FIGS. 4a and 4b are top perspective views showing a physical catchment model for a rainfall runoff experiment according to a first embodiment of the present invention;

FIGS. 5a and 5b are top perspective views showing a physical catchment model for a rainfall runoff experiment in which real terrain subminiatures and developed terrain subminiatures are to be integrated by assembly according to a second embodiment of the present invention;

FIG. 6 is a cross-section view showing a topographic cross section of a real terrain miniature according to present invention;

FIG. 7 is a cross-section view showing a topographic cross section of a developed terrain miniature according to present invention; and

FIG. 8 is a top perspective view showing a rainwater tank disposed at a bottom end of a miniature-holding frame.

### BEST MODE FOR CARRYING OUT THE INVENTION

Hereinafter, a physical catchment model for a rainfall runoff experiment (hereinafter also referred to as “physical catchment construction model”) according to preferred embodiments of the present invention will be described in further detail with reference to the accompanying drawings. It is to be noted that only portions necessary for understanding the technical constitution of the present invention will be described and the description of the remaining portions will be omitted to avoid obscuring the subject matter of the present invention.

The physical catchment construction model according to the preferred embodiments of the present invention is classified into two types, i.e., types 1 and 2 depending on the structure of either a miniature which it is desired to construct or a miniature-holding frame, and the structures of the physical catchment construction model by types will be described hereinafter in detail.

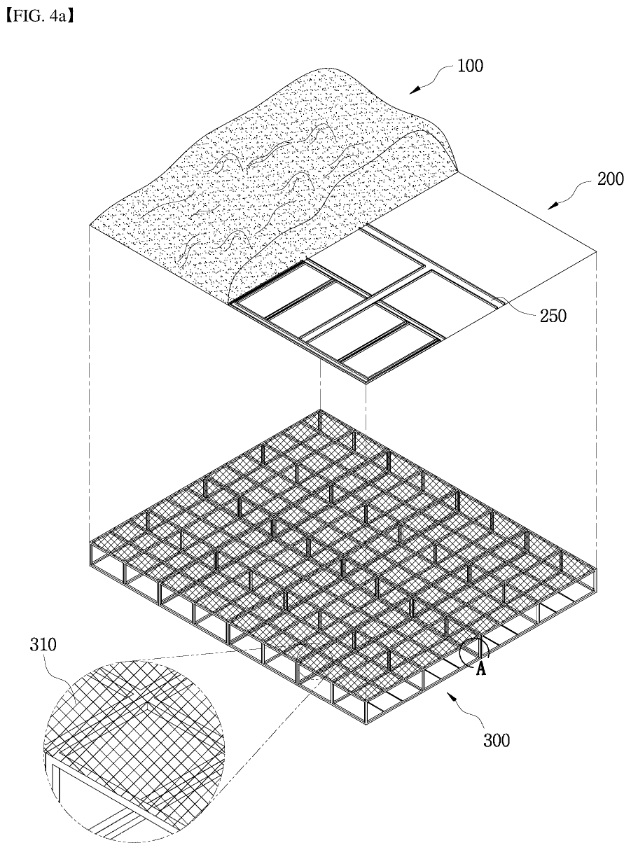

For reference, FIG. 3 is a top perspective view showing the entire structure of a physical catchment model for a rainfall runoff experiment according to the present invention.

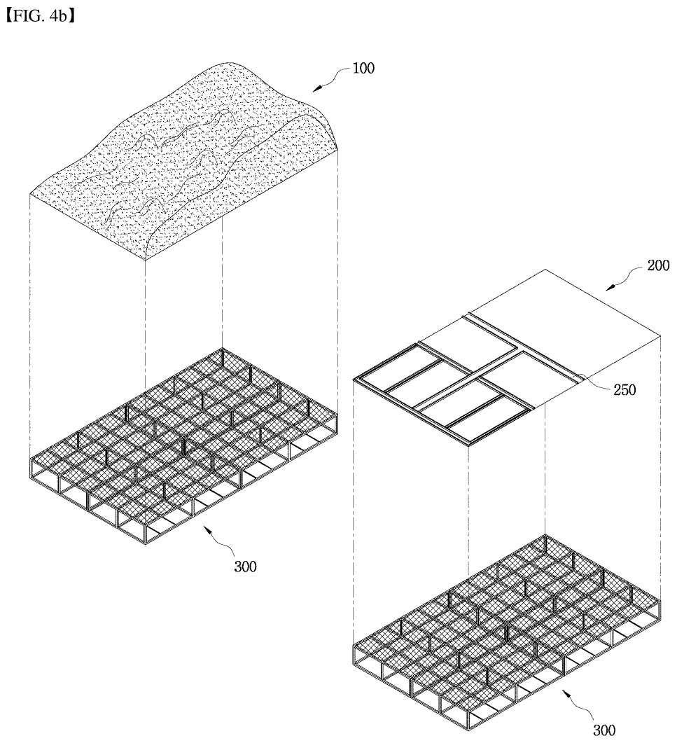

As shown in FIGS. 4a and 4b, the physical catchment construction model (i.e., physical catchment construction model of type 1) according to a first preferred embodiment of the present invention includes: a real terrain miniature 100 formed by reducing a real terrain; a developed terrain miniature 200 formed by reducing the real terrain to a terrain which it is desired to develop according to a development plan; and a miniature-holding frame 300 disposed on the undersides of the real terrain miniature 100 and the developed terrain miniature 200 and configured to support the miniatures.

In addition, the physical catchment construction model has a structure in which the developed terrain miniature 200 is assembled to be disposed adjacent to the real terrain miniature 100, and further comprises a rainwater tank 400 disposed below the miniature-holding frame 300.

For reference, FIGS. 4a and 4b are top perspective views showing a physical catchment model for a rainfall runoff experiment according to a first embodiment of the present invention. FIG. 4a shows a state in which the real terrain miniature 100 and the developed terrain miniature 200 are disposed adjacent to each other, and FIG. 4b shows a state before the real terrain miniature 100 and the developed terrain miniature 200 are not disposed adjacent to each other.

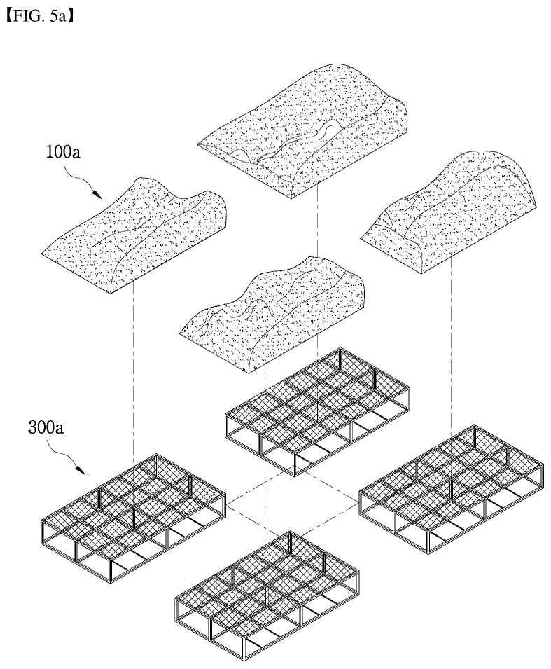

Further, as shown in FIGS. 5a and 5b, the physical catchment construction model (i.e., physical catchment construction model of type 2) according to a second preferred embodiment of the present invention includes: a real terrain miniature 100 formed by assembling a plurality of real terrain subminiatures 100a formed by dividing and reducing a real terrain; a developed terrain miniature 200 formed by assembling a plurality of developed terrain subminiatures 200a formed by reducing the real terrain to a terrain which it is desired to develop according to a development plan; and a plurality of subminiature-holding frames 300a disposed on the undersides of the real terrain miniature 100 and the developed terrain miniature 200 and configured to support the miniatures.

In other words, each of the real terrain subminiatures 100a is a structure formed by dividing the real terrain miniature 100, and each of the developed terrain subminiatures 200a is a structure formed by dividing the developed terrain miniature 200.

In addition, the physical catchment construction model has a structure in which the developed terrain miniature 200 is assembled to be disposed adjacent to the real terrain miniature 100, and further includes a rainwater tank 400 disposed below the miniature-holding frame 300.

For reference, FIGS. 5a and 5b are top perspective views showing a physical catchment model for a rainfall runoff experiment in which real terrain subminiatures and developed terrain subminiatures are to be integrated by assembly according to a second embodiment of the present invention. FIG. 5a shows a state in which a plurality of real terrain subminiatures 100a and a plurality of subminiature-holding frames 300a are separated from each other, and FIG. 5b shows a state in which a plurality of developed terrain subminiatures 200a and a plurality of subminiature-holding frames 300a are separated from each other.

In the physical catchment construction model (i.e., physical catchment construction model of type 2) according to a second preferred embodiment of the present invention, the plurality of subminiature-holding frames 300a sized to correspond to the size of the real terrain miniature 100 may be used for the real terrain subminiatures 100a as shown in FIGS. 5a and 5b, or the miniature-holding frame 300 formed by assembling the plurality of subminiature-holding frames 300a may be used for the real terrain miniature 100 and the developed terrain miniature 200 as shown in FIGS. 4a and 4b.

In addition, the physical catchment construction model according to the present invention may be configured such that when the real terrain miniature 100 and the developed terrain miniature 200 or the real terrain subminiatures 100a and the developed terrain subminiatures 200a are disposed on the miniature-holding frame 300 or the subminiature-holding frames 300a, the miniatures and the subminiatures are either simply placed on the miniature-holding frame 300 or the subminiature-holding frames 300a, or fixedly disposed on the miniature-holding frame 300 or the subminiature-holding frames 300a using an adhesive.

In the meantime, in the physical catchment construction model according to the present invention, the topography of the real terrain miniature 100 is formed by reducing a real terrain in which mountains or hills are formed, which is in a state before the development of the national territory, and the topography of the developed terrain miniature 200 is formed by reducing a terrain planned to be developed for the purpose of developing the national land. Each of the real terrain miniature 100 and the developed terrain miniature 200 that can be used in the present invention is preferably a miniature formed by reducing each of a real terrain and a developed terrain at a scale of approximately 1:75, but the miniature is not necessarily limited to the above-specified scale and can be adjusted appropriately.

In addition, although a rainfall simulator has not illustrated in the accompanying drawings, a rainfall simulator used in a model frame for a rainfall runoff experiment is not particularly limited in its structure and a conventional rainfall simulator may be used.

In the physical catchment construction model of type 2 according to the present invention, the real terrain miniature 100 and the developed terrain miniature 200 are structured such that they are formed by assembling the plurality of real terrain subminiatures 100a and the plurality of developed terrain subminiatures 200a, respectively.

Thus, when the plurality of real terrain subminiatures 100a formed by dividing and reducing a real terrain and the plurality of developed terrain subminiatures 200a formed by reducing a terrain planned to be developed are assembled, the real terrain miniature 100 and the developed terrain miniature 200 are completed.

For reference, in the present invention, the assembly of the plurality of real terrain subminiatures 100a and the plurality of developed terrain subminiatures 200a preferably requires that the real terrain subminiatures 100a and the developed terrain subminiatures 200a should be glued together, respectively, using the actual soil of an area planned to be developed or soil having the property similar to that of the actual soil so as to prevent easy infiltration of artificial rainfall into a gap between the faces of the subminiatures to be assembled.

Meanwhile, a mesh 310 of a lattice structure is preferably mounted on a top of the miniature-holding frame 300 as shown FIG. 4a so as to support the real terrain miniature 100 and the developed terrain miniature 200 and to allow rainfall permeating into the physical catchment construction model to fall into the rainwater tank 400 disposed below the miniature-holding frame 300. The mesh 310 is preferably made of a stainless material or a synthetic resin material.

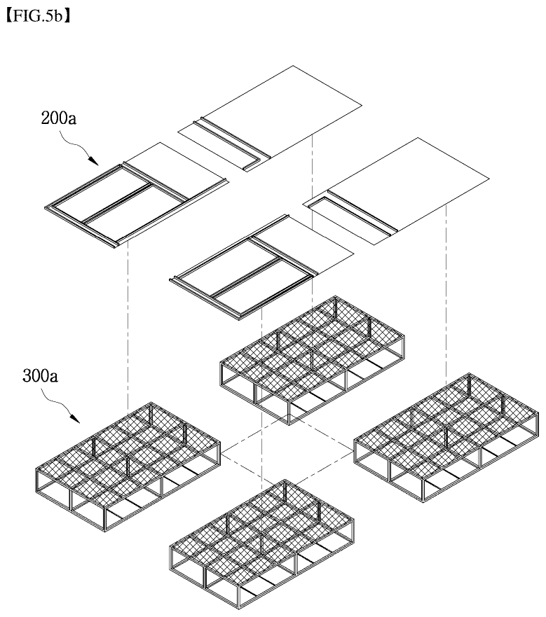

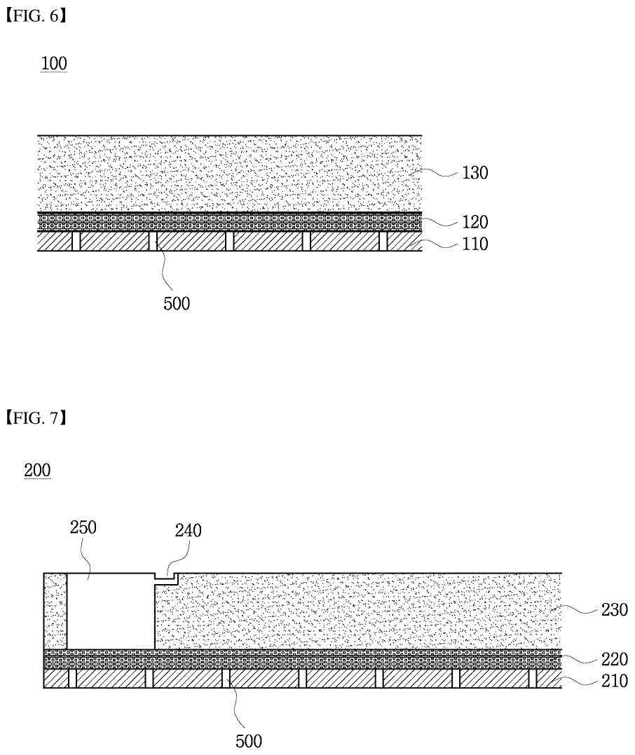

In addition, the real terrain miniature 100 and the developed terrain miniature 200 are structured such that geotextile fabric layers 120 and 220 and soil layers 130 and 230 are respectively sequentially stacked on lower frames 110 and 210 each having a square flat plate shape as shown FIGS. 6 and 7.

As shown in FIGS. 6 and 7, although the real terrain miniature 100 and the developed terrain miniature 200 have been illustrated so that each stacked structure thereof appears in parallel for the sake of convenience, each stacked structure may be formed in a curved pattern depending on the conditions of a real terrain.

For reference, in the present invention, preferably, the entire structure of the real terrain miniature 100 and the developed terrain miniature 200 has a dimension of 10 m×10 m×3 m (length×width×frame height) and the entire structure of the real terrain subminiatures 100a and the developed terrain subminiatures 200a has a dimension of 5 m×5 m×5 m (length×width×frame height), but the dimensions of the miniature and subminiature may be adjusted appropriately depending on the area size or the reduction ratio of a terrain to be developed.

In addition, the miniature-holding frame 300 for holding the real and developed terrain miniatures preferably has the above-mentioned dimension to correspond to the entire area of the real terrain miniature 100 and the developed terrain miniature 200 or the entire area of the real terrain subminiatures 100a and the developed terrain subminiatures 200a as in the terrain miniatures and subminiatures described above. Further, in the case where the subminiature-holding frames 300a are coupled to each other, they are coupled to each other by a welding or fixing means or the subminiature-holding frames 300a at one side and the subminiature-holding frames 300a at the other side are fixedly assembled together and coupled to each other using a clamping means such as a clamp or the like.

For reference, as used herein, the term “miniature-holding frame 300” means a frame having a dimension of 10 m×m×3 m (length×width×frame height) and the term “subminiature-holding frame 300a” means a frame having a dimension of 5 m×5 m×5 m (length×width×frame height).

In the meantime, the real terrain miniature 100 and the developed terrain miniature 200 are structured such that geotextile fabric layers 120 and 220 and soil layers 130 and 230 are respectively sequentially stacked on lower frames 110 and 210 each having a square flat plate shape.

For reference, the drainage channel 240 or the road 250 arranged on the developed terrain miniature 200 and the developed terrain subminiatures 200a may be disposed properly according to a development plan.

In the present invention, the lower frames 110 and 210 have a permeable surface structure or an impermeable surface structure, and the permeable surface structure has a plurality of outlet holes 500 formed therein in such a manner as to be spaced apart from one another at predetermined intervals as shown in FIGS. 6 and 7.

The lower frames 110 and 210 having the impermeable surface structure are not formed with the outlet holes 500, and are intended to implement an area where rock mass or the like is located in the ground, or workpieces or structures are installed in an underground space.

Thus, in the lower frames 110 and 210 having the permeable surface structure, rainwater permeating into the underground through the ground surface falls into the rainwater tank 400 through the plurality of outlet holes 500 formed in the lower frames 110 and 210.

The lower frames 110 and 210 serve to hold the terrain miniatures, and may be made of a metal material, a wooden material or a synthetic resin material. The material of the lower frames 110 and 210 is not particularly limited as long as it holds the terrain miniatures.

In addition, a geotextile fabric used in the geotextile fabric layers 120 and the 220 is a water-permeable polypropylene or polyester fabric which has a soil layer loss preventing and draining function. Examples of the geotextile fabric include a woven fabric, a non-woven fabric, a perforated non-woven fabric, and the like, and the number the stacked geotextile fabric layers can be adjusted appropriately depending on soil properties of a terrain to be actually examined.

In the present invention, the soil layers 130 and 230 are preferably used by filling a lightweight soil or a filling material in the geocell, and the material filled in the geocell depending on the actual soil conditions can be selected properly other than the above-specified material. In addition, the number of material layers stacked in the geocell can also be adjusted appropriately.

The material of the geocell used in the present invention is preferably a synthetic resin material that is used commonly. The filling material is a material that is sintered with the same composition as that of actual local soil. Preferably, the particle size of the filling material that can be used in the present invention is 3 to 10 cm in diameter and is 5 to 15 cm in length and width, but is not necessarily limited to the above-specified range and can be adjusted appropriately depending on actual soil conditions and construction model conditions.

In the present invention, the thicknesses of the lower frames 110 and 210, the geotextile fabric layers 120 and 220, and the soil layers 130 and 230, which constitute the terrain miniatures, may be reduced at a proper ratio after examining the cross section of the real terrain.

In the present invention, in the topography of the developed terrain miniature 200 or the developed terrain subminiatures 200a, the road 250 having a drainage channel 240 is formed on one side or both sides of the miniature or the subminiatures, and rainwater introduced into the drainage channel 240 flows in the rainwater tank 400 through a drain pipe (not shown).

Thus, rainwater having fallen down by the application of artificial rainfall flows out downwardly through the soil layers 130 and 230, the geotextile fabric layers 120 and 220, and the plurality of outlet holes 500 formed at predetermined intervals in the lower frames 110 and 210, and then is collected into the rainwater tank 400. The drainage channel 240 is structured such that rainwater introduced into the drainage channel 240 formed on one side or both sides of the road 250 flows in the rainwater tank 400 through a large-sized drain pipe (not shown) via a small-sized drain pipe (not shown) buried in the underground along the drainage channel 240.

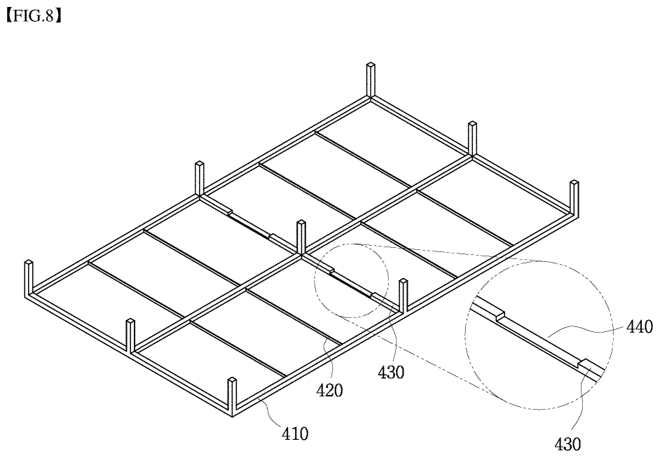

In the meantime, the rainwater tank 400 is implemented as a hexahedral structure with an open top surface to correspond to the shape of the entire undersides of the real terrain miniature 100 and the developed terrain miniature 200 as shown in FIG. 8.

As shown in FIG. 8, the rainwater tank 400 includes an outer wall 410 installed along an edge face thereof and a plurality of inner walls 420 installed inside the outer wall 410 so as to have a height lower than that of the outer wall. A weir 430 formed with an overflow groove 440 is installed at a suitable position inside the rainwater tank 400 so as to prevent rainwater collected in the rainwater tank 400 from flowing out of the rainwater tank 400 and being lost.

In addition, the outflow amount of rainwater introduced in the rainwater tank 400 disposed below the miniature-holding frame 300 is measured using a flow meter or the like so as to enable the prediction of the amount of rainwater flowing out for a predetermined time in a future developed terrain in the development stage of the national land in a real terrain catchment area.

For reference, in the present invention, the topography formed on the developed terrain miniature 200 or the developed terrain subminiatures 200a is configured by referring to the gradient set according to the development plan so that rainwater falling on the ground surface and rainwater flowing in the drain pipe (not shown) can flow to a lower place. In addition, the gradient of the rainwater tank 400 disposed under the developed terrain miniature 200 or the developed terrain subminiature 200 is also formed under the same conditions as those of the gradient formed in the developed terrain so that the rainwater collected in the rainwater tank flows to a lower position of the rainwater tank.

Of course, the gradient of the real terrain miniature 100 and the real terrain subminiatures 100a is also formed under the same conditions as those of the gradient formed in the real terrain, and the gradient of the rainwater tank 400 disposed under the real terrain miniature 100 or the real terrain subminiatures 100a is also formed under the same conditions as those of the gradient formed in the real terrain.

Thus, according to the physical catchment model for rainfall runoff experiment of the present invention, it is structured such that a real terrain miniature is disposed at one side thereof and a developed terrain miniature is disposed at the adjacent other side thereof, so that it is possible to easily compare and measure a change in the amount of rainwater flowing out for a predetermined time during rainfall in an undeveloped real terrain and a developed terrain through the application of artificial rainfall to the physical catchment model, thereby enabling easy establishment of a national land use and development plan in the development planning stage for utilization of national land so that natural disasters caused by the rainfall runoff of land planned to be developed can be prevented in advance.

While the physical catchment model for a rainfall runoff experiment according to the present invention has been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the technical spirit and scope of the present invention.

### BEST MODE

In a best mode for carrying out the present invention, the present invention provides a physical catchment model for a rainfall runoff experiment, including: a real terrain miniature 100 formed by reducing a real terrain; a developed terrain miniature 200 formed by reducing the real terrain to a terrain which it is desired to develop according to a development plan; and a miniature-holding frame 300 disposed on the undersides of the real terrain miniature 100 and the developed terrain miniature 200 and configured to support the miniatures, wherein the physical catchment model has a structure in which the developed terrain miniature 200 is assembled to be disposed adjacent to the real terrain miniature 100, and further includes a rainwater tank 400 disposed below the miniature-holding frame 300.

In addition, in another best mode for carrying out the present invention, the present invention provides a physical catchment model for a rainfall runoff experiment, including: a real terrain miniature 100 formed by assembling a plurality of real terrain subminiatures 100a formed by dividing and reducing a real terrain; a developed terrain miniature 200 formed by assembling a plurality of developed terrain subminiatures 200a formed by reducing the real terrain to a terrain which it is desired to develop according to a development plan; and a plurality of subminiature-holding frames 300a disposed on the undersides of the real terrain miniature 100 and the developed terrain miniature 200 and configured to support the miniatures, wherein the physical catchment model has a structure in which the developed terrain miniature 200 is assembled to be disposed adjacent to the real terrain miniature 100, and further includes a rainwater tank 400 disposed below the miniature-holding frame 300.

The real terrain miniature 100 and the developed terrain miniature 200 may be structured such that geotextile fabric layers 120 and 220 and soil layers 130 and 230 are respectively sequentially stacked on lower frames 110 and 210 each having a square flat plate shape. The developed terrain miniature 200 may include a road 250 having a drainage channel 240 formed on one side or both sides thereof, and rainwater introduced into the drainage channel 240 may be collected in the rainwater tank 400 through a drain pipe.

Each of the lower frames 110 and 210 may include a permeable surface structure or an impermeable surface structure, and the permeable surface structure may have a plurality of outlet holes 500 formed therein in such a manner as to be spaced apart from one another at predetermined intervals. The rainwater tank 400 may be implemented as a hexahedral structure with an open top surface to correspond to the shape of the entire undersides of the real terrain miniature 100 and the developed terrain miniature 200.

### INDUSTRIAL APPLICABILITY

The physical catchment model for a rainfall runoff experiment according to the present invention is an industrially applicable invention since easy establishment of a national land use and development plan is enabled in the development planning stage for utilization of national land so that natural disasters caused by the rainfall runoff of land planned to be developed can be prevented in advance.

1. A physical catchment model for a rainfall runoff experiment, comprising:
a real terrain miniature (100) formed by reducing a real terrain;
a developed terrain miniature (200) formed by reducing the real terrain to a terrain which it is desired to develop according to a development plan; and
a miniature-holding frame (300) disposed on the undersides of the real terrain miniature (100) and the developed terrain miniature (200) and configured to support the miniatures.
wherein the physical catchment model has a structure in which the developed terrain miniature (200) is assembled to be disposed adjacent to the real terrain miniature (100), and further comprises a rainwater tank (400) disposed below the miniature-holding frame (300).

2. A physical catchment model for a rainfall runoff experiment, comprising:
a real terrain miniature (100) formed by assembling a plurality of real terrain subminiatures (100a) formed by dividing and reducing a real terrain;
a developed terrain miniature (200) formed by assembling a plurality of developed terrain subminiatures 200a formed by reducing the real terrain to a terrain which it is desired to develop according to a development plan; and
a plurality of subminiature-holding frames (300a) disposed on the undersides of the real terrain miniature (100) and the developed terrain miniature (200) and configured to support the miniatures,
wherein the physical catchment model has a structure in which the developed terrain miniature (200) is assembled to be disposed adjacent to the real terrain miniature (100), and further comprises a rainwater tank (400) disposed below the miniature-holding frame (300).

3. The physical catchment model for a rainfall runoff experiment according to claim 1, wherein the real terrain miniature (100) and the developed terrain miniature (200) are structured such that geotextile fabric layers (120 and 220) and soil layers (130 and 230) are respectively sequentially stacked on lower frames (110 and 210) each having a square flat plate shape.

4. The physical catchment model for a rainfall runoff experiment according to claim 3, wherein the developed terrain miniature (200) comprises a road (250) having a drainage channel (240) formed on one side or both sides thereof, and rainwater introduced into the drainage channel (240) is collected in the rainwater tank (400) through a drain pipe.

5. The physical catchment model for a rainfall runoff experiment according to claim 3, wherein each of the lower frames (110 and 210) has a permeable surface structure or an impermeable surface structure, and the permeable surface structure has a plurality of outlet holes (500) formed therein in such a manner as to be spaced apart from one another at predetermined intervals.

6. The physical catchment model for a rainfall runoff experiment according to claim 1, wherein the rainwater tank (400) is implemented as a hexahedral structure with an open top surface to correspond to the shape of the entire undersides of the real terrain miniature (100) and the developed terrain miniature (200).

7. The physical catchment model for a rainfall runoff experiment according to claim 2, wherein the real terrain miniature (100) and the developed terrain miniature (200) are structured such that geotextile fabric layers (120 and 220) and soil layers (130 and 230) are respectively sequentially stacked on lower frames (110 and 210) each having a square flat plate shape.

8. The physical catchment model for a rainfall runoff experiment according to claim 7, wherein the developed terrain miniature (200) comprises a road (250) having a drainage channel (240) formed on one side or both sides thereof, and rainwater introduced into the drainage channel (240) is collected in the rainwater tank (400) through a drain pipe.

9. The physical catchment model for a rainfall runoff experiment according to claim 7, wherein each of the lower frames (110 and 210) has a permeable surface structure or an impermeable surface structure, and the permeable surface structure has a plurality of outlet holes (500) formed therein in such a manner as to be spaced apart from one another at predetermined intervals.

10. The physical catchment model for a rainfall runoff experiment according to claim 2, wherein the rainwater tank (400) is implemented as a hexahedral structure with an open top surface to correspond to the shape of the entire undersides of the real terrain miniature (100) and the developed terrain miniature (200).
